(19) United States
(12) Patent Application Publication
(10) Pub. No.: US 2025/0383496 A1
(43) Pub. Date: Dec. 18, 2025

(54) OPTICAL DEVICE, OPTICAL RECEIVER, AND OPTICAL TRANSMITTER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 19/050,608

(22) Filed: Feb. 11, 2025

(30) Foreign Application Priority Data
Jun. 12, 2024 (JP) 2024-095182

(51) Int. Cl. G02B 6/12; G02B 6/122; H04B 10/43

(52) U.S. Cl. CPC G02B 6/12014; G02B 6/1228; H04B 10/43; G02B 2006/12097

(57) ABSTRACT

An optical device includes a substrate, a tapered waveguide that is arranged in a first layer on the substrate and that has a waveguide width that gradually increases from input to output, a rib waveguide that is arranged in a second layer on the substrate, where the second layer is different from the first layer, and overlaps with the tapered waveguide in a plane direction. The rib waveguide includes a rib that has a core width that gradually increases from the input to the output, and slabs that are arranged on both sides of the rib and that have slab widths that gradually increase from the input to the output.

### CROSS-REFERENCE TO RELATED APPLICATION

This application is based upon and claims the benefit of priority of the prior Japanese Patent Application No. 2024-095182, filed on Jun. 12, 2024, the entire contents of which are incorporated herein by reference.

### FIELD

The embodiments discussed herein are related to an optical device, an optical receiver, and an optical transmitter.

### BACKGROUND

An optical input unit of an optical device that adopts a silicon photonics technology includes a substrate-type optical waveguide device that includes an edge coupler for inputting light from an optical fiber and a Polarization Rotator/Polarization Beam Splitter (PR/PBS) that splits paths in accordance with polarization of light that is input from the edge coupler. The edge coupler inputs light from the optical fiber while performing mode field matching with respect to the optical fiber. Further, the PR/PBS is able to split paths in accordance with polarization of light that is input from the edge coupler.
Patent Literature 1: Japanese National Publication of PCT International Application No. 2017-536572
Patent Literature 2: Japanese Laid-open Patent Publication No. 2023-110383
Patent Literature 3: U.S. Patent Application Publication No. 2019/0369333
Patent Literature 4: U.S. Patent Application Publication No. 2009/0297093
Patent Literature 5: Japanese Laid-open Patent Publication No. 2015-090449

However, a conventional optical device includes, for example, an edge coupler that is configured with a SiN waveguide, such as Si₃N₄ (hereinafter, simply referred to as SiN (Silicon Nitride)), and a PR/PBS that is configured with an Si waveguide. The optical device needs to have a function to perform higher-order transformation on signal light while allowing spatial transition of the signal light between different waveguides, such as between the SiN waveguide and the Si waveguide.

### SUMMARY

According to an aspect of an embodiment, an optical device includes a substrate, a tapered waveguide that is arranged in a first layer on the substrate and that has a waveguide width that gradually increases from input to output, and a rib waveguide that is arranged in a second layer on the substrate, the second layer being different from the first layer, and overlaps with the tapered waveguide in a plane direction. The rib waveguide includes a rib that has a core width that gradually increases from the input to the output, and slabs that are arranged on both sides of the rib and that have slab widths that gradually increase from the input to the output.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating an example of an optical device of a first embodiment;

FIG. 2A is a schematic cross-sectional view illustrating an example of a cross-sectional portion taken along a line A-A illustrated in FIG. 1;

FIG. 2B is a schematic cross-sectional view illustrating an example of a cross-sectional portion taken along a line B-B illustrated in FIG. 1;

FIG. 2C is a schematic cross-sectional view illustrating an example of a cross-sectional portion taken along a line C-C illustrated in FIG. 1;

FIG. 3 is a schematic plan view illustrating an example of an optical device of a second embodiment;

FIG. 4A is a schematic cross-sectional view illustrating an example of a cross-sectional portion taken along a line A-A illustrated in FIG. 3;

FIG. 4B is a schematic cross-sectional view illustrating an example of a cross-sectional portion taken along a line B-B illustrated in FIG. 3;

FIG. 4C is a schematic cross-sectional view illustrating an example of a cross-sectional portion taken along a line C-C illustrated in FIG. 3;

FIG. 4D is a schematic cross-sectional view illustrating an example of a cross-sectional portion taken along a line D-D illustrated in FIG. 3;

FIG. 5 is a schematic plan view illustrating an example of an optical device of a third embodiment;

FIG. 6A is a schematic cross-sectional view illustrating an example of a cross-sectional portion taken along a line A-A illustrated in FIG. 5;

FIG. 6B is a schematic cross-sectional view illustrating an example of a cross-sectional portion taken along a line B-B illustrated in FIG. 5;

FIG. 6C is a schematic cross-sectional view illustrating an example of a cross-sectional portion taken along a line C-C illustrated in FIG. 5;

FIG. 6D is a schematic cross-sectional view illustrating an example of a cross-sectional portion taken along a line D-D illustrated in FIG. 5;

FIG. 7 is a diagram for explaining an example of an optical transceiver according to one embodiment;

FIG. 8 is a schematic plan view illustrating an example of an optical device of a comparative example;

FIG. 9A is a schematic cross-sectional view illustrating an example of a cross-sectional portion taken along a line A-A illustrated in FIG. 8;

FIG. 9B is a schematic cross-sectional view illustrating an example of a cross-sectional portion taken along a line B-B illustrated in FIG. 8;

FIG. 9C is a schematic cross-sectional view illustrating an example of a cross-sectional portion taken along a line C-C illustrated in FIG. 8; and

FIG. 9D is a schematic cross-sectional view illustrating an example of a cross-sectional portion taken along a line D-D illustrated in FIG. 8.

### DESCRIPTION OF EMBODIMENTS

### Comparative Example

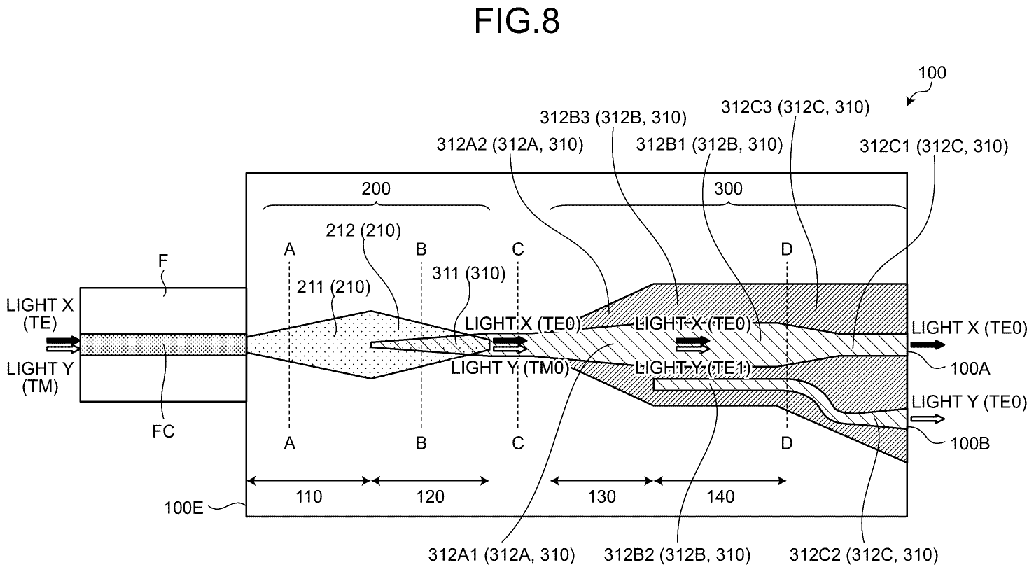

An optical device 100 of a comparative example will be described that is able to perform higher-order transformation on signal light while allowing spatial transition of the signal light between different waveguides, such as a SiN waveguide and a Si waveguide. FIG. 8 is a schematic plan view illustrating an example of the optical device 100 of the comparative example. The optical device 100 illustrated in FIG. 8 is a substrate-type optical waveguide device that includes an optical input unit that is optically connected to an optical fiber F.

The optical device 100 includes an edge coupler 200 that is optically connected to a core FC of the optical fiber F, and a Polarization Beam Splitter (PBS) 300 that is optically connected to the edge coupler 200 and that polarizes and separates light that comes from the edge coupler 200. The edge coupler 200 is a coupler that is arranged on a chip end face 100E of the optical device 100. The edge coupler 200 includes a SiN waveguide 210 that is formed in a first layer and that has a channel structure, and a Si waveguide 310 (311) that is formed in a second layer different from the first layer and that has the channel structure.

The PBS 300 is a polarization multiplexer/demultiplexer that splits signal light that is input from the edge coupler 200 to signal light in two polarization states, such as signal light of an X-polarization component that is Transverse Electric (TE) polarization and signal light of a Y-polarization component that is Transverse Magnetic (TM) polarization. The PBS 300 includes the Si waveguide 310 that has a rib structure. The SiN waveguide 210 has a lower refractive index than the Si waveguide 310, and therefore, it is possible to increase a light mode field. Further, the SiN waveguide 210 has smaller polarization dependence than the Si waveguide 310, and therefore, it is possible to reduce a coupling loss of both of TE light and TM light with respect to the core FC of the optical fiber F.

The SiN waveguide 210 includes an inverse tapered waveguide 211 and a tapered waveguide 212 that is optically coupled with the inverse tapered waveguide 211. The inverse tapered waveguide 211 has a tapered structure in which a core width gradually increases from the chip end face 100E toward the tapered waveguide 212. The tapered waveguide 212 has a tapered structure in which a core width gradually decreases from output of the inverse tapered waveguide 211 toward the Si waveguide 310.

The Si waveguide 310 includes the channel waveguide 311 and a rib waveguide 312 that is optically coupled with the channel waveguide 311. The channel waveguide 311 is a waveguide that has an inverse tapered structure in which a core width gradually decreases from the rib waveguide 312 toward the chip end face 100E. The rib waveguide 312 includes a first rib waveguide 312A in which a slab width gradually increases with distance from the channel waveguide 311, and a second rib waveguide 312B that is optically coupled with the first rib waveguide 312A and that has a constant slab width. Further, the rib waveguide 312 includes a third rib waveguide 312C that is optically coupled with the second rib waveguide 312B and that is optically connected to a first output port 100A and a second output port 100B of the optical device 100.

The first rib waveguide 312A includes a rib 312A1 and slabs 312A2 that are formed on both sides of the rib 312A1. The rib 312A1 is a rib in which a core width gradually increases from the channel waveguide 311 toward the second rib waveguide 312B. The slabs 312A2 are slabs in which slab widths on both sides of the rib 312A1 gradually increase from the channel waveguide 311 toward the second rib waveguide 312B.

The second rib waveguide 312B is a rib that includes a first rib 312B1, slabs 312B3 that are formed on both sides of the first rib 312B1, and a second rib 312B2 that is formed on one of the slabs 312B3. The first rib 312B1 is a rib that has a constant core width from the first rib waveguide 312A toward the third rib waveguide 312C. The slabs 312B3 are slabs in which slab widths on both sides of the first rib 312B1 are constant from the first rib waveguide 312A toward the third rib waveguide 312C. The second rib 312B2 is a rib that is formed on one of the slabs 312B3, that is arranged parallel to the first rib 312B1, and that has a constant core width from the first rib waveguide 312A toward the third rib waveguide 312C.

The third rib waveguide 312C includes a first rib 312C1, slabs 312C3 that are formed on both sides of the first rib 312C1, and a second rib 312C2 that is formed on one of the slabs 312C3. The first rib 312C1 is a rib that is optically connected to the first rib 312B1 of the second rib waveguide 312B and gives output from the second rib waveguide 312B to the first output port 100A that is a terminal end of the optical input unit. The second rib 312C2 is a rib that is optically connected to the second rib 312B2 of the second rib waveguide 312B and gives output from the second rib waveguide 312B to the second output port 100B that is a terminal end of the optical input unit.

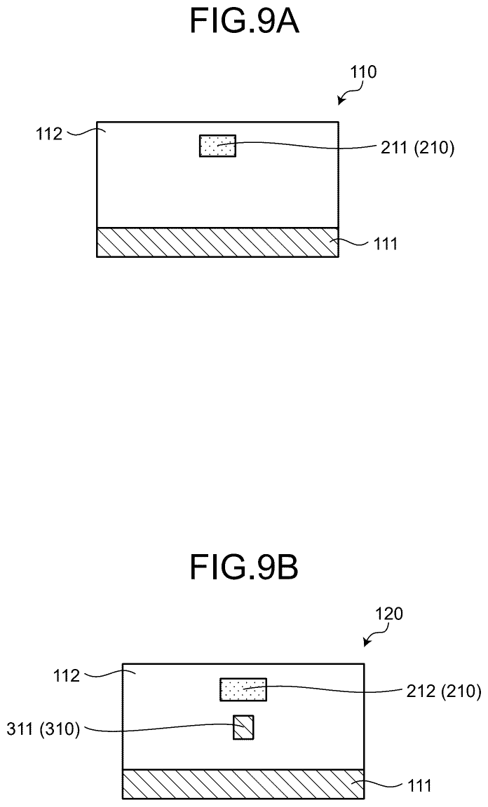

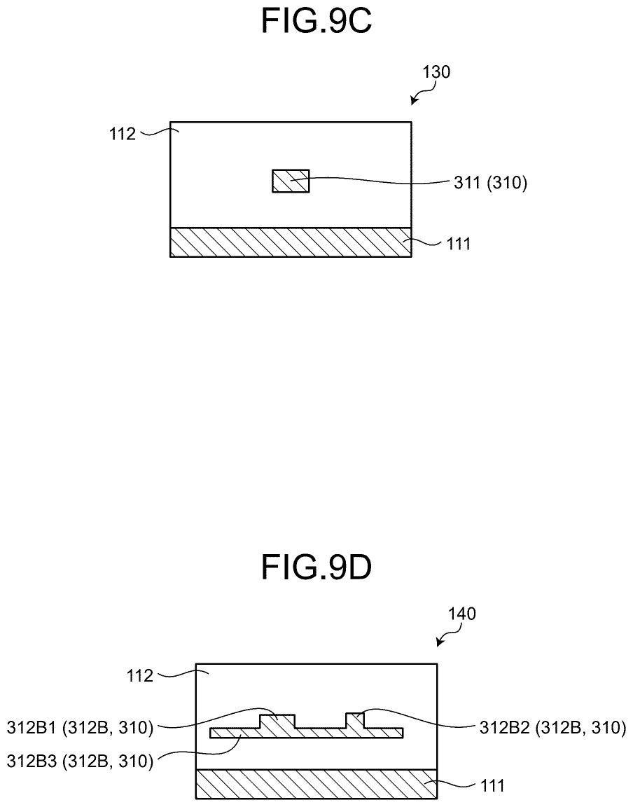

The optical device 100 includes an inverse tapered portion 110, an adiabatic transformation unit 120, a higher-order transformation unit 130, and a directional coupler 140. The inverse tapered portion 110 is configured with the inverse tapered waveguide 211 of the SiN waveguide 210. FIG. 9A is a schematic cross-sectional view illustrating an example of a cross-sectional portion taken along a line A-A illustrated in FIG. 8. A cross-sectional part illustrated in FIG. 9A is a cross-sectional part of the inverse tapered portion 110. The optical device 100 illustrated in FIG. 9A includes a Si substrate 111, a clad layer 112 that is laminated on the Si substrate 111 and that is made of, for example, SiO₂, and the inverse tapered waveguide 211 of the SiN waveguide 210 that is formed in the first layer in the clad layer 112. The inverse tapered portion 110 has different mode fields for the Si waveguide 310 and the core FC of the optical fiber F, and therefore, has a function to reduce a coupling loss with respect to the core FC of the optical fiber F by adjusting the mode fields for the Si waveguide 310 and the core FC of the optical fiber F.

FIG. 9B is a schematic cross-sectional view illustrating an example of a cross-sectional portion taken along a line B-B illustrated in FIG. 8. A cross-sectional part illustrated in FIG. 9B is a cross-sectional part of the adiabatic transformation unit 120. The optical device 100 includes the Si substrate 111, the clad layer 112, the tapered waveguide 212 of the SiN waveguide 210 that is formed in the first layer in the clad layer 112, and the channel waveguide 311 of the Si waveguide 310 that is formed in the second layer in the clad layer 112. The optical device 100 constitutes the adiabatic transformation unit 120 by arranging the tapered waveguide 212 and the channel waveguide 311 in an overlapping manner in a plane direction. The adiabatic transformation unit 120 allows gradual spatial transition of light from the tapered waveguide 212 of the SiN waveguide 210 toward the channel waveguide 311 of the Si waveguide 310. The adiabatic transformation unit 120 allows spatial transition of X-polarized TE light to X-polarized TE0 light and allows spatial transition of Y-polarized TM light to Y-polarized TM0 light from the tapered waveguide 212 toward the channel waveguide 311.

FIG. 9C is a schematic cross-sectional view illustrating an example of a cross-sectional portion taken along a line C-C illustrated in FIG. 8. The optical device 100 illustrated in FIG. 9C includes the Si substrate 111, the clad layer 112, and the channel waveguide 311 of the Si waveguide 310 that is formed in the second layer in the clad layer 112.

Furthermore, the higher-order transformation unit 130 includes the first rib waveguide 312A of the Si waveguide 310 and allows higher-order transformation of light, which comes from the channel waveguide 311, in the first rib waveguide 312A. The rib 312A1 of the first rib waveguide 312A transmits and outputs the X-polarized TE0 light, which is input from the channel waveguide 311, to the first rib 312B1 of the second rib waveguide 312B. The rib 312A1 performs higher-order transformation on the Y-polarized TM0 light, which is input from the channel waveguide 311, to Y-polarized TE1 light, and outputs the Y-polarized TE1 light to the first rib 312B1 in the second rib waveguide 312B.

The directional coupler 140 includes the first rib 312B1 of the second rib waveguide 312B and the second rib 312B2 in the second rib waveguide 312B. FIG. 9D is a schematic cross-sectional view illustrating an example of a cross-sectional portion taken along a line D-D illustrated in FIG. 8. A cross-sectional part illustrated in FIG. 9D is a cross-sectional part of the directional coupler 140. The optical device 100 illustrated in FIG. 9D includes the Si substrate 111, the clad layer 112, and the second rib waveguide 312B of the Si waveguide 310 that is formed in the second layer in the clad layer 112. The first rib 312B1 of the second rib waveguide 312B transmits and outputs the X-polarized TE0 light, which is input from the first rib waveguide 312A, to the first rib 312C1 of the third rib waveguide 312C. Further, the first rib 312B1 transforms the Y-polarized TE1 light, which is input from the first rib waveguide 312A, to Y-polarized TE0 light, and allows spatial transition of the light to the second rib 312B2 in the second rib waveguide 312B.

The first rib 312C1 in the third rib waveguide 312C transmits and outputs the X-polarized TE0 light from the first rib 312B1 in the second rib waveguide 312B to the first output port 100A. Further, the second rib 312C2 in the third rib waveguide 312C transmits and outputs the Y-polarized TE0 light from the second rib 312B2 in the second rib waveguide 312B to the second output port 100B. In other words, the PBS 300 separately outputs the X-polarized TE0 light to the first output port 100A and the Y-polarized TE0 light to the second output port 100B.

Operation of the optical device 100 of the comparative example will be described below. The adiabatic transformation unit 120 of the optical device 100 of the comparative example, when the X-polarized TE light coming from the optical fiber F is input from the inverse tapered portion 110, allows spatial transition of the X-polarized TE light to the X-polarized TE0 light from the tapered waveguide 212 toward the channel waveguide 311.

The first rib waveguide 312A in the higher-order transformation unit 130 outputs, from the channel waveguide 311, the X-polarized TE0 light that is subjected to the spatial transition to the first rib 312B1 of the second rib waveguide 312B. The first rib 312B1 in the second rib waveguide 312B in the directional coupler 140 outputs the X-polarized TE0 light coming from the first rib 312B1 to the first output port 100A via the first rib 312C1 of the third rib waveguide 312C.

Further, the adiabatic transformation unit 120 of the optical device 100, when the Y-polarized TM light coming from the optical fiber F is input from the inverse tapered portion 110, allows spatial transition of the Y-polarized TM light to the Y-polarized TM0 light from the tapered waveguide 212 toward the channel waveguide 311.

The first rib waveguide 312A in the higher-order transformation unit 130 performs higher-order transformation on the Y-polarized TM0 light, which is subjected to the spatial transition and which comes from the channel waveguide 311, to the Y-polarized TEL light, and outputs the Y-polarized TE1 light that is obtained by the higher-order transformation to the first rib 312B1 of the second rib waveguide 312B. The second rib 312B2 in the second rib waveguide 312B in the directional coupler 140 allows spatial transition while transforming the Y-polarized TE1 light coming from the first rib 312B1 to the Y-polarized TE0 light. Further, the second rib 312B2 in the second rib waveguide 312B outputs the Y-polarized TE0 light that is subjected to the spatial transition to the second output port 100B via the second rib 312C2 in the third rib waveguide 312C.

In other words, in the optical device 100, it is possible to separately output the X-polarized TE0 light to the first output port 100A and the Y-polarized TE0 light to the second output port 100B in accordance with the polarized state of light that is input from the edge coupler 200.

However, in the optical device 100 of the comparative example, the Si waveguide 310 of the adiabatic transformation unit 120 is the channel waveguide 311, and therefore, side wall roughening occurs due to etching at the time of formation of waveguides. As a result, due to the side wall roughening of the channel waveguide 311, light scattering occurs and an optical loss or optical reflection increases. In addition, the influence of the side wall roughening is small when the core width of the channel waveguide 311 is small, but the influence of the side wall roughening increase with an increase in the core width of the channel waveguide 311.

In addition, optical connection of the PBS 300 is established on the subsequent stage of the edge coupler 200, and the adiabatic transformation unit 120 and the higher-order transformation unit 130 are connected in a multi-stage manner, so that the waveguide length increases and the size of the optical device 100 increases.

### (a) First Embodiment

To cope with this, embodiments of an optical device that are able to perform higher-order transformation while allowing spatial transition of signal light between different waveguides, that are able to reduce a loss and reflection in an optical input unit, and that contribute to reduction in size will be described in detail below with reference to the drawings. Meanwhile, the present invention is not limited by the embodiments below. Further, the embodiments described below may be appropriately combined as long as no contradiction is derived.

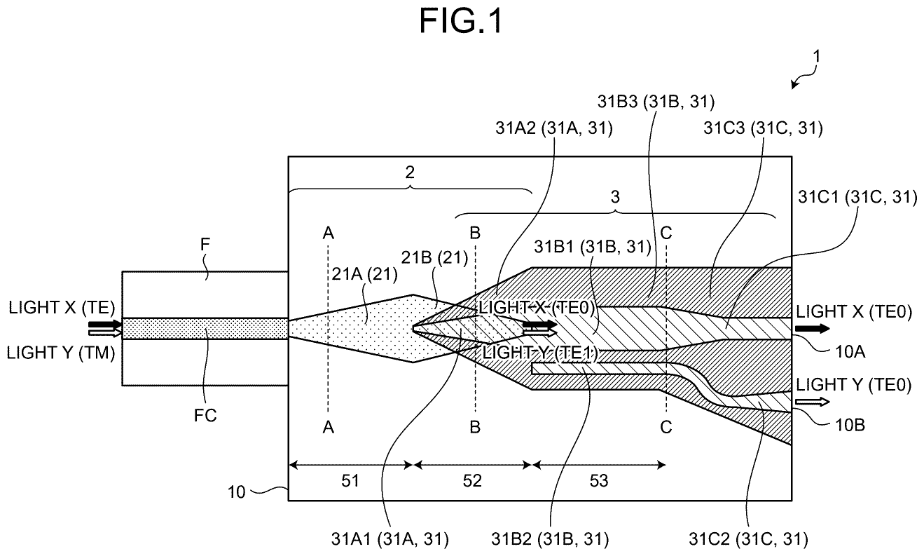

FIG. 1 is a schematic plan view illustrating an example of an optical device 1 of the first embodiment. The optical device 1 illustrated in FIG. 1 is a substrate-type optical waveguide device that includes an optical input unit that is optically connected to the optical fiber F. The optical device 1 includes an edge coupler 2 that is arranged on a chip end face 10 of the optical device 1 and that is optically connected to the core FC of the optical fiber F, and a Polarization Beam Splitter (PBS) 3 that is optically connected to the edge coupler 2 and that polarizes and separates light coming from the edge coupler 2. The edge coupler 2 includes a SiN waveguide 21 that is formed in a first layer and that has a channel structure, and a Si waveguide 31 that is formed in a second layer different from the first layer and that has a rib structure.

The PBS 3 is a polarization multiplexer/demultiplexer that splits signal light that is input from the edge coupler 200 to signal light in two orthogonal polarization states, such as signal light of an X-polarization component that is TE polarization and signal light of a Y-polarization component that is TM polarization. The PBS 3 includes the Si waveguide 31 that is formed in the second layer and that has a rib structure. The SiN waveguide 21 has a lower refractive index than the Si waveguide 31, and therefore, it is possible to increase a light mode field. Further, the SiN waveguide 21 has smaller polarization dependence than the Si waveguide 31, and therefore, it is possible to reduce a coupling loss of both of TE light and TM light with respect to the core FC of the optical fiber F.

The SiN waveguide 21 includes an inverse tapered waveguide 21A and a tapered waveguide 21B that is optically coupled with the inverse tapered waveguide 21A. The inverse tapered waveguide 21A has a tapered structure in which a core width gradually increases from the chip end face 10 toward the tapered waveguide 21B. The tapered waveguide 21B has a tapered structure in which a core width gradually decreases from output of the inverse tapered waveguide 21A toward the Si waveguide 31.

The Si waveguide 31 includes a first rib waveguide 31A in which a slab width gradually increases with distance from the tapered waveguide 21B, and a second rib waveguide 31B that is optically coupled with the first rib waveguide 31A and that has a constant slab width. The Si waveguide 31 includes a third rib waveguide 31C that is optically coupled with the second rib waveguide 31B and that is optically connected to a first output port 10A and a second output port 10B of the optical device 1.

The first rib waveguide 31A includes a rib 31A1 and slabs 31A2 that are formed on both sides of the rib 31A1. The rib 31A1 is a rib in which a core width gradually increases from the first rib waveguide 31A toward the second rib waveguide 31B. The slabs 31A2 are slabs in which slab widths on both sides of the rib 31A1 increase from the first rib waveguide 31A to the second rib waveguide 31B.

The second rib waveguide 31B includes a first rib 31B1, slabs 31B3 that are formed on both sides of the first rib 31B1, and a second rib 31B2 that is formed on one of the slabs 31B3. The first rib 31B1 is a rib that has a constant core width from the first rib waveguide 31A toward the third rib waveguide 31C. The slabs 31B3 are slabs in which slab widths on both sides of the first rib 31B1 are constant from the first rib waveguide 31A toward the third rib waveguide 31C. The second rib 31B2 is a rib that is formed on one of the slabs 31B3, that is arranged parallel to the first rib 31B1, and that has a constant core width from the first rib waveguide 31A toward the third rib waveguide 31C.

The third rib waveguide 31C includes a first rib 31C1, slabs 31C3 that are formed on both sides of the first rib 31C1, and a second rib 31C2 that is formed on one of the slabs 31C3. The first rib 31C1 is a rib that is optically connected to the first rib 31B1 of the second rib waveguide 31B and gives output from the second rib waveguide 31B to the first output port 10A that is a terminal end of the optical input unit. The second rib 31C2 is a rib that is optically connected to the second rib 31B2 of the second rib waveguide 31B and gives output from the second rib waveguide 31B to the second output port 10B that is a terminal end of the optical input unit.

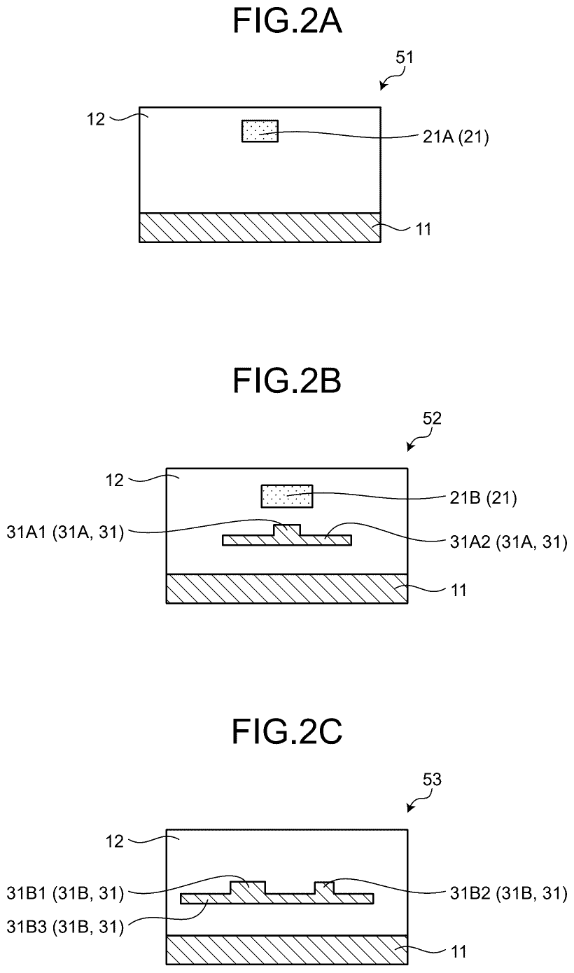

The optical device 1 includes an inverse tapered portion 51, a transformation unit 52, and a directional coupler 53. The inverse tapered portion 51 is configured with the inverse tapered waveguide 21A of the SiN waveguide 21. FIG. 2A is a schematic cross-sectional view illustrating an example of a cross-sectional portion taken along a line A-A illustrated in FIG. 1. A cross-sectional part illustrated in FIG. 2A is a cross-sectional part of the inverse tapered portion 51. The optical device 1 illustrated in FIG. 2A includes a Si substrate 11, a clad layer 12 that is laminated on the Si substrate 11 and that is made of, for example, SiO₂, and the inverse tapered waveguide 21A of the SiN waveguide 21 that is formed in the first layer in the clad layer 12. The inverse tapered portion 51 has different mode fields for the Si waveguide 31 and the core FC of the optical fiber F, and therefore, has a function to reduce a coupling loss with respect to the core FC of the optical fiber F by adjusting the mode fields for the Si waveguide 31 and the core FC of the optical fiber F.

FIG. 2B is a schematic cross-sectional view illustrating an example of a cross-sectional portion taken along a line B-B illustrated in FIG. 1. A cross-sectional part illustrated in FIG. 2B is a cross-sectional part of the transformation unit 52. The optical device 1 illustrated in FIG. 2B includes the Si substrate 11 and the clad layer 12 that is laminated on the Si substrate 11. The optical device 1 includes the tapered waveguide 21B of the SiN waveguide 21 that is formed in the first layer in the clad layer 12 and the first rib waveguide 31A of the Si waveguide 31 that is formed in the second layer in the clad layer 12. In the optical device 1, the transformation unit 52 is constituted by arranging the tapered waveguide 21B and the first rib waveguide 31A in an overlapping manner in a plane direction. The transformation unit 52 allows gradual higher-order transformation and spatial transition of light from the tapered waveguide 21B of the SiN waveguide 21 toward the first rib waveguide 31A of the Si waveguide 31. The transformation unit 52 allows spatial transition of X-polarized TE light to X-polarized TE0 light and allows higher-order transformation of Y-polarized TM light to Y-polarized TE1 light from the tapered waveguide 21B toward the first rib waveguide 31A.

The directional coupler 53 includes a first rib 31B1 of the second rib waveguide 31B and the second rib 31B2 in the second rib waveguide 31B. FIG. 2C is a schematic cross-sectional view illustrating an example of a cross-sectional portion taken along a line C-C illustrated in FIG. 1. A cross-sectional part illustrated in FIG. 2C is a cross-sectional part of the directional coupler 53. The optical device 1 illustrated in FIG. 2C includes the Si substrate 11, the clad layer 12 that is laminated on the Si substrate 11, and the second rib waveguide 31B of the Si waveguide 31 that is formed in the second layer in the clad layer 12. The first rib 31B1 of the second rib waveguide 31B transmits and outputs the X-polarized TE0 light, which is input from the first rib waveguide 31A, to the first rib 31C1 of the third rib waveguide 31C. The first rib 31B1 allows spatial transition of the Y-polarized TEL light, which is input from the first rib waveguide 31A, to the Y-polarized TE0 light in the second rib 31B2 in the second rib waveguide 31B.

The first rib 31C1 in the third rib waveguide 31C transmits and outputs the X-polarized TE0 light from the first rib 31B1 in the second rib waveguide 31B to the first output port 10A. Further, the second rib 31C2 in the third rib waveguide 31C transmits and outputs the Y-polarized TE0 light from the second rib 31B2 in the second rib waveguide 31B to the second output port 10B. In other words, the PBS 3 separately outputs the X-polarized TE0 light to the first output port 10A and the Y-polarized TE0 light to the second output port 10B.

Operation of the optical device 1 of the first embodiment will be described below. The transformation unit 52 of the optical device 1, when the X-polarized TE light coming from the optical fiber F is input from the inverse tapered portion 51, allows spatial transition of the X-polarized TE light to the X-polarized TE0 light from the tapered waveguide 21B toward the first rib waveguide 31A while performing the higher-order transformation.
the first rib waveguide 31A in the transformation unit 52 transmits and outputs the X-polarized TE0 light that is subjected to the spatial transition to the first rib 31B1 of the second rib waveguide 31B. The first rib 31B1 in the second rib waveguide 31B in the directional coupler 53 outputs the X-polarized TE0 light coming from the first rib 31B1 to the first output port 10A via the first rib 31C1 of the third rib waveguide 31C.

Further, the transformation unit 52 of the optical device 1, when the Y-polarized TM light coming from the optical fiber F is input from the inverse tapered portion 51, performs spatial transition of the Y-polarized TM light from the tapered waveguide 21B toward the first rib waveguide 31A while allowing higher-order transformation of the Y-polarized TM light to the Y-polarized TE1 light.

The first rib waveguide 31A in the transformation unit 52 outputs the Y-polarized TEL light that is subjected to the spatial transition to the first rib 31B1 of the second rib waveguide 31B. The second rib 31B2 in the second rib waveguide 31B in the directional coupler 53 allows spatial transition while transforming the Y-polarized TE1 light coming from the first rib 31B1 to the Y-polarized TE0. Further, the second rib 31B2 in the second rib waveguide 31B outputs the Y-polarized TE0 light that is subjected to the spatial transition to the second output port 10B via the second rib 31C2 in the third rib waveguide 31C.

In other words, the optical device 1 is able to separately output the X-polarized TE0 light and the Y-polarized TE0 light in accordance with a polarization state of light that is input through the edge coupler 2. In addition, in the optical device 1, the transformation unit 52 is configured with the tapered waveguide 21B of the SiN waveguide 21 and the first rib waveguide 31A of the Si waveguide 31. The first rib waveguide 31A includes the rib 31A1 in which the core width gradually increases from input to output, and the slabs 31A2 that are arranged on both sides of the rib 31A1 and in which the slab widths gradually increase from input to output. The transformation unit 52 has functions of adiabatic transformation and higher-order transformation. As a result, it is possible to reduce the waveguide length that is used for the adiabatic transformation and the higher-order transformation, which largely contributes to reduction in the size of the optical device 1.

The transformation unit 52 performs higher-order transformation of the TM light to the TE1 light while adiabatically allowing spatial transition of light from the tapered waveguide 21B of the SiN waveguide 21 to the first rib waveguide 31A of the Si waveguide 31, for example. Furthermore, the Si waveguide 31 of the transformation unit 52 is configured with a rib structure rather than a channel structure, so that it is possible to prevent side wall roughening that has occurred due to the conventional channel structure, and it is possible to reduce optical loss and reflection in the transformation unit 52. Moreover, the transformation unit 52 has functions of the adiabatic transformation and the higher-order transformation, so that it is possible to reduce the waveguide length that is used for the adiabatic transformation and the higher-order transformation and it is possible to reduce the size of the optical device 1.

In the first rib waveguide 31A of the transformation unit 52, the TE0 light passes as the TE0 light; however, because an effective refractive index of the TM0 light is close to an effective refractive index of the TE1 light, the TM0 light is transformed to the TE1 light. Furthermore, in the directional coupler 53, optical confinement of the TEL light in the first rib 31B1 is lower as compared to the TE0 light, so that the Y-polarized light is subjected to spatial transition from the first rib 31B1 to the second rib 31B2 as the TE0 light. As a result, only the TE1 light is transitioned to the second rib 31B2, and is spatially separated from the TE0 light.

Meanwhile, the first rib waveguide 31A of the transformation unit 52 in the optical device 1 of the first embodiment strongly confines the TE light, so that optical coupling of the TE light tends to be difficult, and efficiency of adiabatic transformation may be reduced. Therefore, an embodiment that copes with the situation as described above will be described below as a second embodiment.

### (b) Second Embodiment

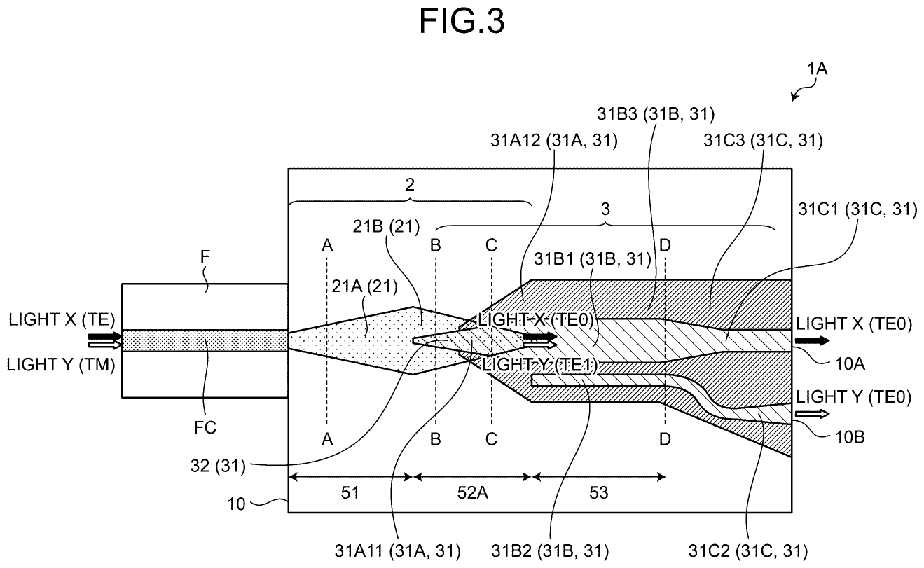

FIG. 3 is a schematic plan view illustrating an example of an optical device 1A of the second embodiment. Meanwhile, the same components as those of the optical device 1 of the first embodiment are denoted by the same reference symbols, and explanation of the same components and the same operation will be omitted. The optical device 1 of the first embodiment and the optical device 1A of the second embodiment are different in that a transformation unit 52A that includes the tapered waveguide 21B of the SiN waveguide 21, a channel waveguide 32 of the Si waveguide 31, and the first rib waveguide 31A is provided.

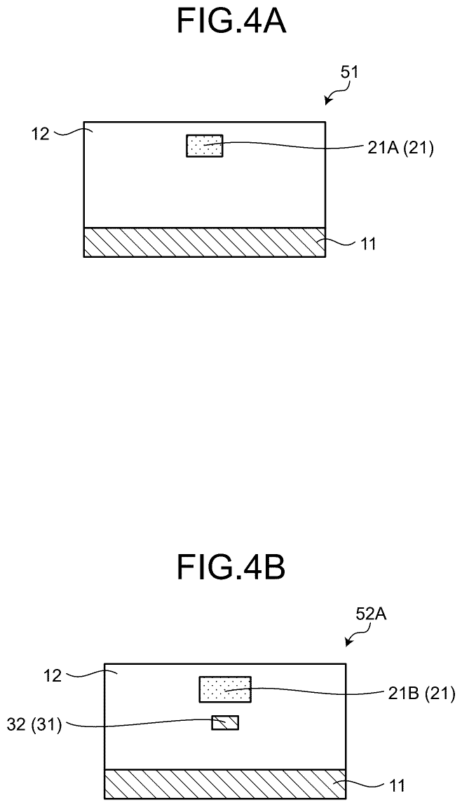

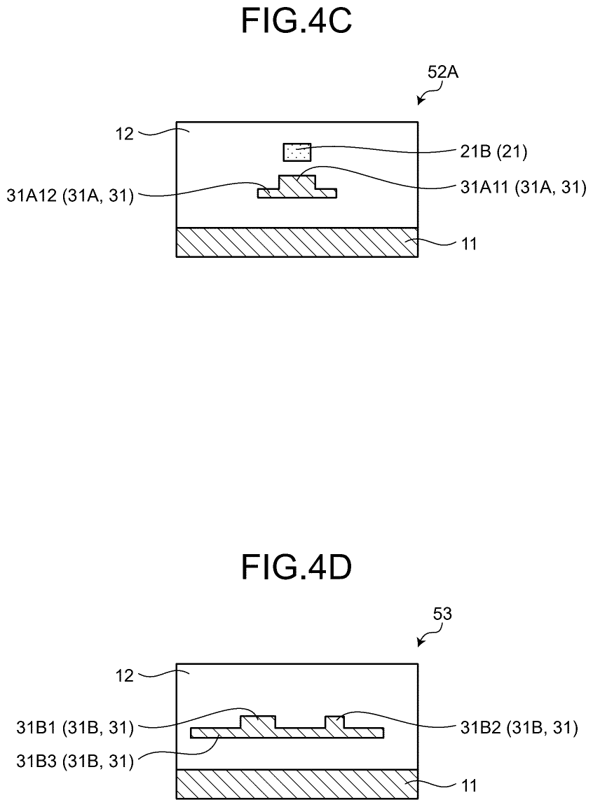

The optical device 1A includes the inverse tapered portion 51, the transformation unit 52A, and the directional coupler 53. The inverse tapered portion 51 includes the inverse tapered waveguide 21A of the SiN waveguide 21. FIG. 4A is a schematic cross-sectional view illustrating an example of a cross-sectional portion taken along a line A-A illustrated in FIG. 3. A cross-sectional part illustrated in FIG. 4A is a cross-sectional part of the inverse tapered portion 51. The optical device 1A illustrated in FIG. 2A includes the Si substrate 11, the clad layer 12 that is laminated on the Si substrate 11, and the inverse tapered waveguide 21A of the SiN waveguide 21 that is formed in the first layer in the clad layer 12.

FIG. 4B is a schematic cross-sectional view illustrating an example of a cross-sectional portion taken along a line B-B illustrated in FIG. 3. A cross-sectional part illustrated in FIG. 4B is a cross-sectional part of an input stage of the transformation unit 52A. The optical device 1A illustrated in FIG. 4B includes the Si substrate 11 and the clad layer 12 that is laminated on the Si substrate 11. The optical device 1A further includes the tapered waveguide 21B of the SiN waveguide 21 that is formed in the first layer in the clad layer 12, and the channel waveguide 32 of the Si waveguide 31 that is formed in the second layer in the clad layer 12.

FIG. 4C is a schematic cross-sectional view illustrating an example of a cross-sectional portion taken along a line C-C illustrated in FIG. 3. A cross-sectional part illustrated in FIG. 4C is a cross-sectional part of an output stage of the transformation unit 52A. The optical device 1A illustrated in FIG. 4C includes the Si substrate 11 and the clad layer 12 that is laminated on the Si substrate 11. The optical device 1A further includes the tapered waveguide 21B of the SiN waveguide 21 that is formed in the first layer in the clad layer 12 and the first rib waveguide 31A of the Si waveguide 31 that is formed in the second layer in the clad layer 12. The first rib waveguide 31A includes a rib 31A11 that is optically connected to the channel waveguide 32 and slabs 31A12 that are arranged on both sides of the rib 31A11 and in which waveguide widths gradually increase from the channel waveguide 32 toward the second rib waveguide 31B. The rib 31A11 of the first rib waveguide 31A is optically connected to the first rib 31B1 of the second rib waveguide 31B. The slabs 31A12 of the first rib waveguide 31A are connected to the slabs 31B3 of the second rib waveguide 31B. In the optical device 1A, the transformation unit 52A is constituted by arranging the tapered waveguide 21B, the channel waveguide 32, and the first rib waveguide 31A in an overlapping manner in a plane direction.

The transformation unit 52A allows spatial transition while performing gradual higher-order transformation of light from the tapered waveguide 21B of the SiN waveguide 21 toward the first rib waveguide 31A via the channel waveguide 32 of the Si waveguide 31. The transformation unit 52A allows spatial transition of the X-polarized TE light to the X-polarized TE0 light from the tapered waveguide 21B toward the first rib waveguide 31A, and allows spatial transition while performing higher-order transformation of the Y-polarized TM light to the Y-polarized TE1 light.

The directional coupler 53 includes the first rib 31B1 of the second rib waveguide 31B and the second rib 31B2 in the second rib waveguide 31B. FIG. 4D is a schematic cross-sectional view illustrating an example of a cross-sectional portion taken along a line D-D illustrated in FIG. 3. A cross-sectional part illustrated in FIG. 4C is a cross-sectional part of the directional coupler 53. The optical device 1A illustrated in FIG. 4C includes the Si substrate 11, the clad layer 12 that is laminated on the Si substrate 11, and the second rib waveguide 31B of the Si waveguide 31 that is formed in the second layer in the clad layer 12. The first rib 31B1 of the second rib waveguide 31B transmits and outputs the X-polarized TE0 light, which is input from the first rib waveguide 31A, to the first rib 31C1 of the third rib waveguide 31C. The first rib 31B1 allows spatial transition of the Y-polarized TEL light, which is input from the first rib waveguide 31A, to the Y-polarized TE0 light in the second rib 31B2 in the second rib waveguide 31B.
the first rib 31C1 in the third rib waveguide 31C transmits and outputs the X-polarized TE0 light from the first rib 31B1 in the second rib waveguide 31B to the first output port 10A. Further, the second rib 31C2 in the third rib waveguide 31C transmits and outputs the Y-polarized TE0 light from the second rib 31B2 in the second rib waveguide 31B to the second output port 10B. In other words, the PBS 3 separately outputs the X-polarized TE0 light to the first output port 10A and the Y-polarized TE0 light to the second output port 10B.

Operation of the optical device 1A of the second embodiment will be described below. The transformation unit 52A of the optical device 1A, when the X-polarized TE light coming from the optical fiber F is input from the inverse tapered portion 51, performs higher-order transformation while allowing spatial transition of the X-polarized TE light to the X-polarized TE0 light from the tapered waveguide 21B to the first rib waveguide 31A via the channel waveguide 32.

The first rib waveguide 31A in the transformation unit 52A transmits and outputs the X-polarized TE0 light that is subjected to the spatial transition to the first rib 31B1 of the second rib waveguide 31B. The first rib 31B1 in the second rib waveguide 31B in the directional coupler 53 outputs the X-polarized TE0 light coming from the first rib 31B1 to the first output port 10A via the first rib 31C1 of the third rib waveguide 31C.
the transformation unit 52A of the optical device 1A, when the Y-polarized TM light coming from the optical fiber F is input from the inverse tapered portion 51, performs higher-order transformation while allowing spatial transition of the Y-polarized TM light to the Y-polarized TE1 light from the tapered waveguide 21B toward the first rib waveguide 31A via the channel waveguide 32.

The first rib waveguide 31A in the transformation unit 52A outputs the Y-polarized TEL light that is subjected to the spatial transition to the first rib 31B1 of the second rib waveguide 31B. The second rib 31B2 in the second rib waveguide 31B in the directional coupler 53 allows spatial transition while performing higher-order transformation of the Y-polarized TE1 light coming from the first rib 31B1 to the Y-polarized TE0. Further, the second rib 31B2 in the second rib waveguide 31B outputs the Y-polarized TE0 light that is subjected to the spatial transition to the second output port 10B via the second rib 31C2 in the third rib waveguide 31C.

In other words, in the optical device 1A, light that is input to the optical device 1A via the edge coupler 2 is separately output as the X-polarized TE0 light and the Y-polarized TE0 light in accordance with the polarized state of light that is input to the PBS 3. In addition, in the optical device 1A, the transformation unit 52A is configured with the tapered waveguide 21B of the SiN waveguide 21, the channel waveguide 32 of the Si waveguide 31, and the first rib waveguide 31A. The transformation unit 52A has functions of the adiabatic transformation and the higher-order transformation, so that it is possible to reduce the waveguide length that is used for the adiabatic transformation and the higher-order transformation and contribute to reduction in the size of the optical device 1A.

In the transformation unit 52A, an end of the Si waveguide 31 is configured with the channel waveguide 32, so that it is possible to weaken optical confinement and improve efficiency of adiabatic transformation (efficiency of optical transition) from the SiN waveguide 21 to the si waveguide 31.

In addition, in the transformation unit 52A, the mode field may rapidly change between the channel waveguide 32 and the first rib waveguide 31A, and a radiation loss may occur. However, the slabs 31A2 of the first rib waveguide 31A are configured such that the slab widths gradually increase from the channel waveguide 32 toward the second rib waveguide 31B. As a result, it is possible to avoid a situation in which the mode field rapidly changes between the channel waveguide 32 and the first rib waveguide 31A in the transformation unit 52A, so that it is possible to prevent occurrence of a radiation loss.

Meanwhile, in the optical device 1A of the second embodiment, the example has been described in which the first rib 31B1 and the second rib 31B2 of the second rib waveguide 31B in the directional coupler 53 have the same core widths. However, embodiments are not limited to this example, and a different embodiment will be described below as a third embodiment.

### (c) Third Embodiment

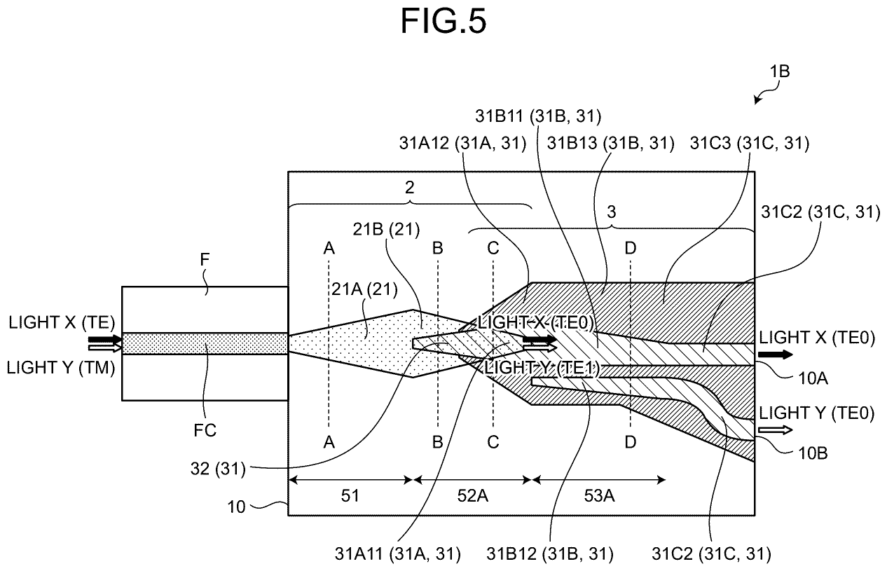

FIG. 5 is a schematic plan view illustrating an example of an optical device 1B of the third embodiment. Meanwhile, the same components as those of the optical device 1A of the second embodiment are denoted by the same reference symbols, and explanation of the same components and the same operation will be omitted. The optical device 1A of the second embodiment and the optical device 1B of the third embodiment are different in that a directional coupler 53A in which the waveguide widths of a first rib 31B11 and a second rib 31B12 in the second rib waveguide 31B are tapered is provided.

The second rib waveguide 31B includes the first rib 31B11, slabs 31B13 that are arranged on both sides of the first rib 31B11, and the second rib 31B12. The first rib 31B11 in the second rib waveguide 31B is a rib in which a core width decreases from the channel waveguide 32 toward the first rib 31C1 of the third rib waveguide 31C. The second rib 31B12 of the second rib waveguide 31B is a rib in which a core width gradually increases from the first rib waveguide 31A toward the second rib 31C2 of the third rib waveguide 31C.

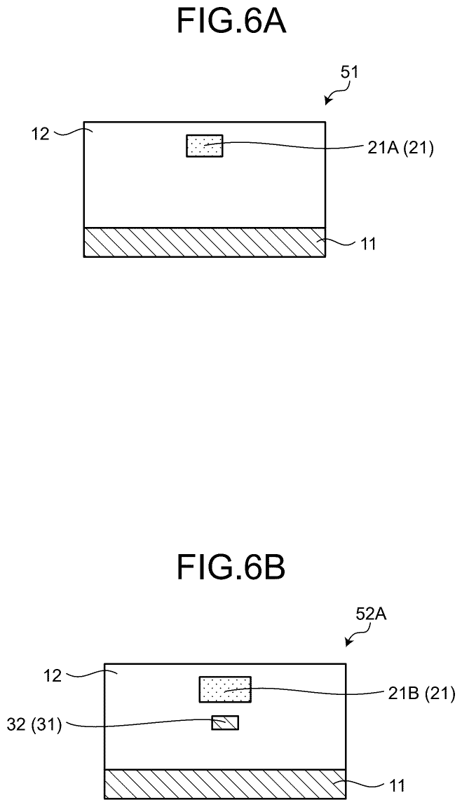

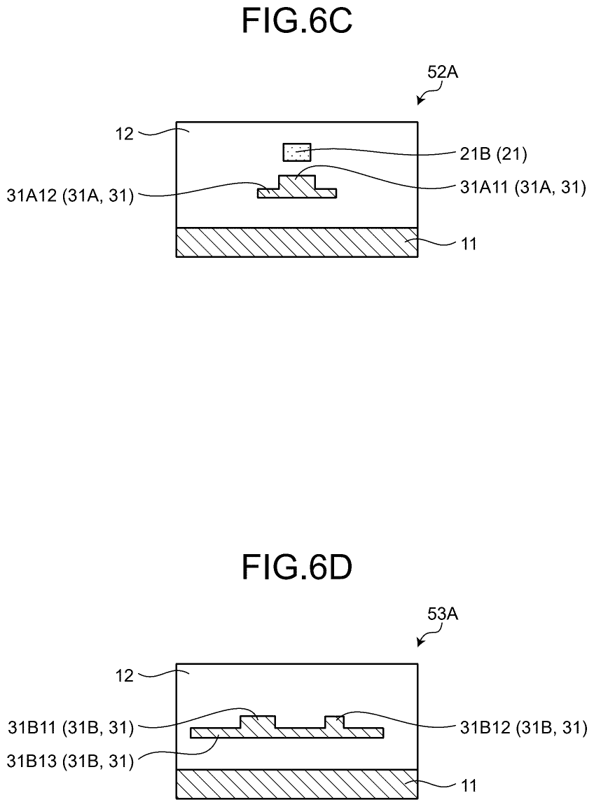

The optical device 1B includes the inverse tapered portion 51, the transformation unit 52A, and the directional coupler 53A. The inverse tapered portion 51 includes the inverse tapered waveguide 21A of the SiN waveguide 21. FIG. 6A is a schematic cross-sectional view illustrating an example of a cross-sectional portion taken along a line A-A illustrated in FIG. 5. A cross-sectional part illustrated in FIG. 6A is a cross-sectional part of the inverse tapered portion 51. The optical device 1B illustrated in FIG. 6A includes the Si substrate 11, the clad layer 12, and the inverse tapered waveguide 21A of the SiN waveguide 21 that is formed in the first layer in the clad layer 12.

FIG. 6B is a schematic cross-sectional view illustrating an example of a cross-sectional portion taken along a line B-B illustrated in FIG. 5. A cross-sectional part illustrated in FIG. 6B is a cross-sectional part of the input stage of the transformation unit 52A. The optical device 1B illustrated in FIG. 6B includes the Si substrate 11, the clad layer 12, the tapered waveguide 21B of the SiN waveguide 21 that is formed in the first layer in the clad layer 12, and the channel waveguide 32 of the Si waveguide 31 that is formed in the second layer in the clad layer 12.

FIG. 6C is a schematic cross-sectional view illustrating an example of a cross-sectional portion taken along a line C-C illustrated in FIG. 5. A cross-sectional part illustrated in FIG. 6C is a cross-sectional part of the output stage of the transformation unit 52A. The optical device 1B illustrated in FIG. 6C includes the Si substrate 11, the clad layer 12, the tapered waveguide 21B of the SiN waveguide 21 that is formed in the first layer in the clad layer 12, and the first rib waveguide 31A of the Si waveguide 31 that is formed in the second layer in the clad layer 12. The first rib waveguide 31A includes the rib 31A11 that is optically connected to the channel waveguide 32 and the slabs 31A12 that are arranged on both sides of the rib 31A11 and in which waveguide widths gradually increase from the channel waveguide 32 toward the second rib waveguide 31B. The rib 31A11 of the first rib waveguide 31A is optically connected to the first rib 31B1 of the second rib waveguide 31B. The slabs 31A12 of the first rib waveguide 31A are connected to the slabs 31B3 of the second rib waveguide 31B. The transformation unit 52A allows spatial transition while performing gradual higher-order transformation of light from the tapered waveguide 21B of the SiN waveguide 21 toward the first rib waveguide 31A via the channel waveguide 32 of the Si waveguide 31. The transformation unit 52A allows spatial transition of the X-polarized TE light to the X-polarized TE0 light from the tapered waveguide 21B toward the first rib waveguide 31A, and allows spatial transition while performing higher-order transformation of the Y-polarized TM light to the Y-polarized TE1 light.

The directional coupler 53A includes the first rib 31B11 of the second rib waveguide 31B and the second rib 31B12 in the second rib waveguide 31B. FIG. 6D is a schematic cross-sectional view illustrating an example of a cross-sectional portion taken along a line D-D illustrated in FIG. 5. A cross-sectional part illustrated in FIG. 6D is a cross-sectional part of the directional coupler 53A. The optical device 1B illustrated in FIG. 6D includes the Si substrate 11, the clad layer 12, and the second rib waveguide 31B of the Si waveguide 31 that is formed in the second layer in the clad layer 12. The first rib 31B11 of the second rib waveguide 31B transmits and outputs the X-polarized TE0 light, which is input from the first rib waveguide 31A, to the first rib 31C1 of the third rib waveguide 31C. The first rib 31B11 allows spatial transition of the Y-polarized TE1 light, which is input from the first rib waveguide 31A, to the Y-polarized TE0 light in the second rib 31B12 in the second rib waveguide 31B.

The first rib 31C1 in the third rib waveguide 31C transmits and outputs the X-polarized TE0 light from the first rib 31B11 in the second rib waveguide 31B to the first output port 10A. Further, the second rib 31C2 in the third rib waveguide 31C transmits and outputs the Y-polarized TE0 light from the second rib 31B12 in the second rib waveguide 31B to the second output port 10B. In other words, the PBS 3 separately outputs the X-polarized TE0 light to the first output port 10A and the Y-polarized TE0 light to the second output port 10B.

Operation of the optical device 1B of the third embodiment will be described below. The transformation unit 52A of the optical device 1B, when the X-polarized TE light coming from the optical fiber F is input from the inverse tapered portion 51, performs higher-order transformation while allowing spatial transition of the X-polarized TE light to the X-polarized TE0 light from the tapered waveguide 21B toward the first rib waveguide 31A via the channel waveguide 32.

The first rib waveguide 31A in the transformation unit 52A transmits and outputs the X-polarized TE0 light that is subjected to the spatial transition to the first rib 31B11 of the second rib waveguide 31B. The first rib 31B11 in the second rib waveguide 31B in the directional coupler 53 outputs the X-polarized TE0 light coming from the first rib 31B11 to the first output port 10A via the first rib 31C1 of the third rib waveguide 31C.

The transformation unit 52A of the optical device 1B, when the Y-polarized TM light coming from the optical fiber F is input from the inverse tapered portion 51, performing higher-order transformation while allowing spatial transition of the Y-polarized TM light to the Y-polarized TE1 light from the tapered waveguide 21B to the first rib waveguide 31A via the channel waveguide 32.

The first rib waveguide 31A in the transformation unit 52A outputs the Y-polarized TE1 light that is subjected to the spatial transition to the first rib 31B11 of the second rib waveguide 31B. The second rib 31B12 in the second rib waveguide 31B in the directional coupler 53A allows spatial transition while performing higher-order transformation of the Y-polarized TEL light coming from the first rib 31B11 to the Y-polarized TE0. Further, the second rib 31B12 in the second rib waveguide 31B outputs the Y-polarized TE0 light that is subjected to the spatial transition to the second output port 10B via the second rib 31C2 in the third rib waveguide 31C.

In other words, in the optical device 1B, light that is input to the optical device 1B through the edge coupler 2 is separately output as the X-polarized TE0 light and the Y-polarized TE0 light in accordance with the polarized state of light that is input to the PBS 3. In addition, in the optical device 1B, the transformation unit 52A is configured with the tapered waveguide 21B of the SiN waveguide 21, the channel waveguide 32 of the Si waveguide 31, and the first rib waveguide 31A. The transformation unit 52A has functions of adiabatic transformation and higher-order transformation, and therefore, it is possible to reduce the waveguide length that is used for the adiabatic transformation and the higher-order transformation, which largely contributes to reduction in the size of the optical device 1B.

In the directional coupler 53A, the first rib 31B11 and the second rib 31B12 in the second rib waveguide 31B have tapered shapes in which the core widths continuously change. As a result, the core width of the directional coupler 53A is tapered so as to be continuously changed, so that optical transition efficiency increases, and it is possible to improve coupling efficiency of the directional coupler 53A and reduce the waveguide length of the directional coupler 53A.

Meanwhile, the case has been described as an example in which the optical device 1 (1A and 1B) of one embodiment includes the edge coupler 2 and the PBS 3 that is optically connected to the edge coupler 2, but it may be possible to arrange a Polarization Rotator (PR) that polarizes and rotates signal light instead of the PBS 3, and appropriate modification may be made Furthermore, in the optical device 1 (1A and 1B), it may be possible to adopt a cross waveguide, in which a SiN waveguide and a Si waveguide cross each other, instead of the edge coupler 2.

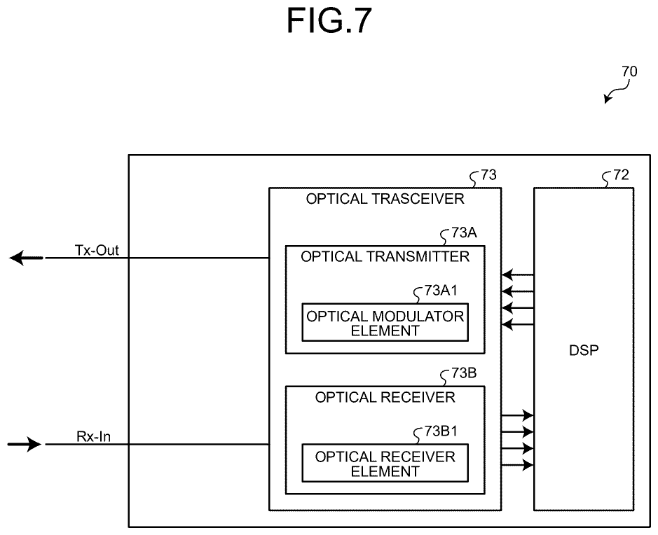

FIG. 7 is a diagram for explaining an example of an optical transceiver 70 according to one embodiment. The optical transceiver 70 illustrated in FIG. 7 is connected to an output-side optical fiber and an input-side optical fiber. The optical transceiver 70 includes a Digital Signal Processor (DSP) 72 and an optical transceiver 73. The optical transceiver 73 includes an optical transmitter 73A and an optical receiver 73B. The DSP 72 is an electrical component that performs digital signal processing. The DSP 72 performs processing, such as encoding, on transmission data, generates an electrical signal that includes the transmission data, and outputs the generated electrical signal to the optical transmitter 73A. Further, the DSP 72 acquires an electrical signal that includes reception data from the optical receiver 73B, performs processing, such as decoding, on the acquired electrical signal, and obtains the reception data.

A light source (not illustrated) includes, for example, a laser diode or the like, generates light at a predetermined wavelength, and supplies the light to the optical transmitter 73A and the optical receiver 73B. The optical transmitter 73A modulates the light that is supplied from the light source, by using the electrical signal that is output from the DSP 72, and outputs the obtained transmission light to the optical fiber. The optical transmitter 73A includes an optical modulator element 73A1 that, when the light that is supplied from the light source propagates through a waveguide, modulates the light by an electrical signal that is input to the optical modulator and generates transmission light.

The optical receiver 73B includes an optical receiver element 73B1 that receives an optical signal from the optical fiber and demodulates the received light by using light that is supplied from the light source. Further, the optical receiver 73B converts the demodulated received light to an electrical signal, and outputs the converted electrical signal to the DSP 72. In the optical receiver 73B, an optical device of a substrate-type optical waveguide element that guides light is incorporated.

Meanwhile, for the sake of simplicity of explanation, the example has been described in which the optical transceiver 70 incorporates therein the optical transmitter 73A and the optical receiver 73B, but the optical transceiver 70 may incorporate therein any one of the optical transmitter 73A and the optical receiver 73B. For example, it may be possible to adopt an optical device to the optical transceiver 70 that incorporates therein the optical receiver 73B, and an appropriate modification may be made.

Furthermore, the components of each of the units illustrated in the drawings need not always be physically configured in the manner illustrated in the drawings. In other words, specific forms of distribution and integration of each of the units are not limited to those illustrated in the drawings, and all or part of the units may be functionally or physically distributed or integrated in arbitrary units depending on various loads or use conditions.

Moreover, all or an arbitrary part of various kinds of processing functions that are implemented by the apparatuses may be realized by a Central Processing Unit (CPU) (or a microcomputer, such as a Micro Processing Unit (MPU) or a Micro Controller Unit (MCU)). Furthermore, all or an arbitrary part of the various kinds of processing functions may be implemented by a program that is analyzed and executed by the CPU, or may be realized by hardware using wired logic.

According to one aspect, it is possible to perform higher-order transformation while allowing spatial transition of signal light between different waveguides.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a substrate;
a tapered waveguide that is arranged in a first layer on the substrate and that has a waveguide width that gradually increases from input to output; and
a rib waveguide that is arranged in a second layer on the substrate, the second layer being different from the first layer, and overlaps with the tapered waveguide in a plane direction, wherein
the rib waveguide includes
a rib that has a core width that gradually increases from the input to the output; and
slabs that are arranged on both sides of the rib and that have slab widths that gradually increase from the input to the output.

2. The optical device according to claim 1, wherein
the rib waveguide includes
a channel waveguide;
the rib that is optically connected to an output end of the channel waveguide and that has a core width that gradually increases from the input to the output; and
the slabs that are arranged on both sides of the rib and that have slab widths that gradually increase from the input to the output.

3. The optical device according to claim 1, wherein
the tapered waveguide is made of a material that includes SiN, and
the rib waveguide is made of a material that includes Si.

4. The optical device according to claim 1 further comprising:
a different rib waveguide that is arranged in the second layer and that is optically connected to the rib waveguide, wherein
the different rib waveguide includes
a first rib that is optically connected to the rib;
different slabs that are arranged on both sides of the first rib, and
a second rib that is arranged on one of the different slabs and that is arranged parallel to the first rib.

5. The optical device according to claim 4, wherein the first rib and the second rib in the different rib waveguide have same core widths.

6. The optical device according to claim 4, wherein the first rib and the second rib in the different rib waveguide have core widths that are continuously changed.

7. An optical receiver comprising:
an optical receiver element that converts received signal light to an electrical signal, wherein
the optical receiver element includes
a substrate;
a tapered waveguide that is arranged in a first layer on the substrate and that has a waveguide width that gradually increases from input to output; and
a rib waveguide that is arranged in a second layer on the substrate, the second layer being different from the first layer, and overlaps with the tapered waveguide in a plane direction, and
the rib waveguide includes
a rib that has a core width that gradually increases from the input to the output; and
slabs that are arranged on both sides of the rib and that have slab widths that gradually increase from the input to the output.

8. An optical transmitter comprising:
an optical modulator element that modulates guided light in accordance with an electrical signal, wherein
the optical modulator element includes
a substrate;
a tapered waveguide that is arranged in a first layer on the substrate and that has a waveguide width that gradually increases from input to output; and
a rib waveguide that is arranged in a second layer on the substrate, the second layer being different from the first layer, and overlaps with the tapered waveguide in a plane direction, and
the rib waveguide includes
a rib that has a core width that gradually increases from the input to the output; and
slabs that are arranged on both sides of the rib and that have slab widths that gradually increase from the input to the output.
